(19) United States
(12) Patent Application Publication
(10) Pub. No.: US 2007/0121093 A1
(43) Pub. Date: May 31, 2007

(54) METHOD FOR MEASURING OVERLAY ERROR IN EXPOSURE MACHINE

(76) Inventor: Po-Ching Lin, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,682

(22) Filed: Apr. 21, 2006

(30) Foreign Application Priority Data
Nov. 29, 2005 (TW) 94141855

(51) Int. Cl. G03B 27/32

(52) U.S. Cl. 355/77; 430/311; 355/55

(57) ABSTRACT

A method for measuring the overlay error of an exposure machine is provided. The method includes disposing a pre-fabricated matching mask and a pre-fabricated matching wafer in two exposure machines and performing an exposure. Then, the image data obtained from the two exposure machines are subtracted from each other to eliminate the error resulting from the matching mask and the matching wafer. Therefore, a more accurate assessment of the overlay error between the two machines can be obtained and a more effective control of the variation between the machines can be achieved.

### CROSS-REFERENCE TO RELATED APPLICATION

This application claims the priority benefit of Taiwan application serial no. 94141855, filed on Nov. 29, 2005. All disclosure of the Taiwan application is incorporated herein by reference.

### BACKGROUND OF THE INVENTION

1. Field of the Invention

The present invention relates to a method for measuring overlay error in an exposure machine. More particularly, the present invention relates to a method of obtaining overlay error between two exposure machines by exposing with identical tools.

2. Description of the Related Art

At present, the semiconductor industry mainly uses a deep ultraviolet excimer laser wafer stepper to carry out the fabrication of 0.25 μm width devices. With the improvement in the quality of lenses, the precision of mask and wafer support platform and the development of high-value aperture, the KrF 248 nm scanner is able to advance device fabrication into the 0.18 μm width era.

However, due to the physical limitation for a particular wavelength together with the difficulties of fabricating a mask when the dimension of a device is reduced, the ArF 193 nm photolithographic technique has been developed. The ArF 193 nm photolithographic technique can be classified into a single-layered photoresist process and a double-layered photoresist process. The single-layered photoresist is a continuation of the conventional i-line and the conventional KrF 248 nm exposure model. The ArF 193 nm excimer laser has a very good resolution in optical photolithography. When it is applied to the fabrication of 0.13 μm devices with the addition of a phase shift mask, optical proximity effect correction mask and an etching process, its line width can be reduced to as small as 100 nm.

Both the aforementioned stepper and scanner are equipment that depends on the photolithographic process. The only difference is that the stepper has a larger exposure surface. Hence, most photo-exposure operations can be carried out in a single illumination operation by placing the wafer on a movable platform. In other words, it is easier to control the accuracy. On the other hand, the scanner has a smaller exposure area but a higher lens quality so that the exposure operation can be divided into a number of illumination areas. Furthermore, the depth of focus for a not-so-flat wafer is longer so that a larger range of surface planarity for the wafer and a larger range of focusing error can be compensated. Hence, the scanner is much more suitable for performing advanced photolithographic process.

Yet, it does not matter much if a stepper or a scanner is used, there is always some errors between the machines when two or more different machines are used to carry out a single process or the same machine is used to carry out different processes. The error is the so-called overlay error. The conventional method for measuring the overlay error includes performing an exposure by disposing a standard mask and a naked wafer on a testing machine and a mother machine. Then, according to the image data obtained from the exposure, the variation in the testing machine is measured. However, the measured value can be affected by the error between the aforementioned standard mask and a standard wafer so that the measurement is not accurate enough. Thus, it is very difficult to perform an accurate correction of the machines. Moreover, the conventional method is constrained by the photoresist so that the method cannot be applied to different types of light exposure machines.

### SUMMARY OF THE INVENTION

Accordingly, at least one objective of the present invention is to provide a method for measuring the overlay error of an exposure machine that includes the exposure of a set of matching mask and matching wafer in two exposure machines, respectively. After subtracting the images resulting from the two exposure machines, the overlay error of the two machines is obtained so that a better control of the variation between the two machines can be achieved.

To achieve these and other advantages and in accordance with the purpose of the invention, as embodied and broadly described herein, the invention provides a method for measuring the overlay error of an exposure machine. The measuring method includes the following steps. First, a set of matching mask and matching wafer is exposed in a reference exposure machine to obtain a first image. Then, the same set of matching mask and matching wafer is exposed in a testing machine to obtain a second image. Thereafter, the second image is subtracted from the first image to obtain a third image. Finally, the linear error in the third image is eliminated to obtain the overlay error.

According to one embodiment of the present invention, the exposing operation further includes adjusting the image of the reference machine and the testing machine to match, as closely as possible, the image on the matching wafer.

According to one embodiment of the present invention, the matching mask is used to fabricate the matching wafer.

According to one embodiment of the present invention, in the step of using the matching mask to fabricate the matching wafer, a best machine is selected according to the conditions of multiple machines to serve as a mother machine. Then, a matching mask is used to fabricate the matching wafer.

According to one embodiment of the present invention, the machine conditions include stage accuracy, scan distortion, stage stepping error and mirror bending error.

According to one embodiment of the present invention, the testing machine and the reference machine are stepper machines or scanner machines.

According to one embodiment of the present invention, the linear error includes a wafer-wise linear error and a shot-wise linear error.

According to one embodiment of the present invention, the wafer-wise linear error includes a shift error, a scaling error and a rotation error.

According to one embodiment of the present invention, the shot-wise linear error includes a scaling error and a rotation error.

In the present invention, the same set of matching mask and matching wafer is exposed in two machines separately and then the resulting images of the two machines are subtracted from each other. Therefore, the error resulting from exposing the set of matching mask and matching wafer in a single machine can be eliminated so as to obtain a more accurate overlay error value.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating of the method for measuring the overlay error of an exposure machine according to one embodiment of the present invention.

FIG. 2 is a series of diagrams illustrating the method of measuring the overlay error of an exposure machine according to one embodiment of the present invention.

FIG. 3 shows a few images captured by an exposure machine according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

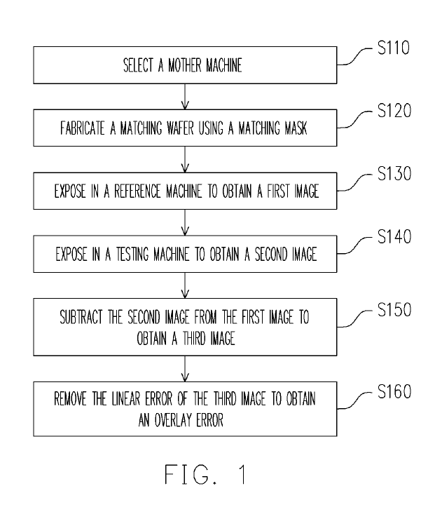

FIG. 1 is a flowchart of the method for measuring the overlay error of an exposure machine according to one embodiment of the present invention. As shown in FIG. 1, first, a matching wafer is fabricated. Then, the same set of tools is exposed in two machines. Finally, the exposed images are subtracted from each other so that the overlay error can be accurately measured. The detail of each step is described as follows.

First, a number of machine conditions are checked, and a best machine is selected from a number of machines to serve as a mother machine (in step S110). The machine conditions includes various related parameters such as stage accuracy, scan distortion, stage stepping error and mirror bending error. However, the parameters are not limited as such. In general, the user can refer to other kinds of machine conditions as the situation demands without departing from the scope of the present invention. Furthermore, a stepper has a larger error and a limited modifiable range while a scanner has a higher precision and better distortion criteria. Hence, a scanner is often used as the mother machine.

Thereafter, a matching mask is set up in the selected mother machine to fabricate the matching wafer (in step S120). The process of fabricating the matching wafer includes film deposition, mother machine calibration, exposure, etching operation and wafer identification code labeling, and so on. In general, there is no particular limitation in the fabrication process.

Then, the set of matching mask and matching wafer is installed on a reference machine and an exposure is performed to obtain a first image (in step S130). When the exposure is processed, the image generated by the reference machine is adjusted according to the image on the matching wafer so that the image is as close to the image on the matching wafer as possible. As a result, the image closest to the matching wafer image is selected as a first image.

Similarly, through using the aforementioned method, the same set of matching mask and matching wafer is installed in a testing machine, and an exposure is performed to obtain a second image (in step S140). The foregoing reference machine and testing machine can be steppers or scanners, for example. However, there is no limitation on the type of exposure machines to be deployed.

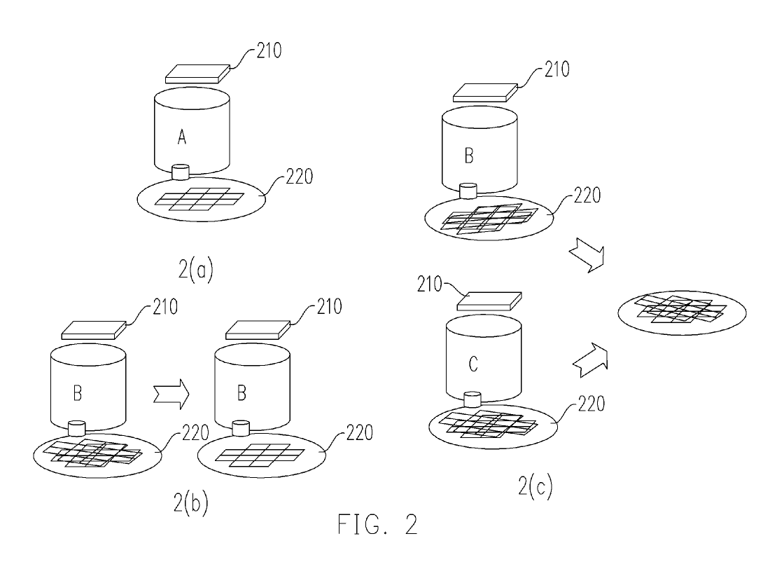

Thereafter, the second image and the first image obtained from the two foregoing exposures are mutually subtracted to obtain a third image (in step S150). FIG. 2 schematically illustrates the method for measuring the overlay error of an exposure machine according to one embodiment of the present invention. As shown in FIG. 2(a), the machine A is chosen as the mother machine and the matching mask 210 is used to fabricate the matching wafer 220. Next, as shown in FIG. 2(b), the matching mask 210 and the matching wafer 220 are installed in the machine B and the image generated by the machine B is adjusted to be as close to the image on the matching wafer 220 as possible. Then, as shown in FIG. 2(c), the same set of matching mask 210 and matching wafer 220 is exposed in the machine B and the machine C to obtain a first image and a second image respectively. The two images are subtracted from each other to obtain a third image.

After the third image is obtained, the linear error of the third image can be computed. When the linear error is removed from the third image, the overlay error between the two machines is obtained (in step S160). The foregoing linear error includes wafer-wise linear error and shot-wise linear error. The wafer-wise linear error is the overall shifting error between the two images on the wafer, and the shot-wise linear error is the shifting error of the shots on the wafer between the two images.

In addition, the wafer-wise linear error may include shifting error, scaling error and rotation error of the wafer, and the shot-wise linear error may include scaling error and rotation error of the shots, for example.

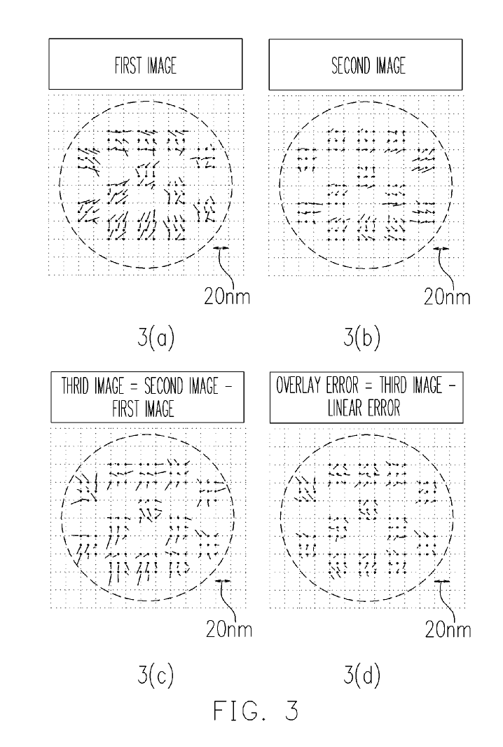

FIG. 3 illustrates a few images captured by an exposure machine according to one embodiment of the present invention. FIG. 3(a) shows the first image obtained by performing an exposure with a reference machine. FIG. 3(b) shows the second image obtained by performing an exposure with a testing machine. FIG. 3(c) shows the third image obtained after subtracting the first image from the second image. FIG. 3(d) shows the image obtained after eliminating the linear error from the third image. Thus, a user may be able to compute the overlay error between the two machines through the image in FIG. 3(d). In FIG. 3, each square has a side length of about 20 nm and each point is a measuring point. Furthermore, the line extending out from each measuring point can be regarded as a vector representing the direction and magnitude of the shift of the measuring point. Moreover, the nine points within a square as shown in FIG. 3 represent a single shot on the wafer. Therefore, by computing the shift of the measuring points within each shot, the linear error of the shot can be obtained. Thereafter, the shot-wise linear error can be used to compute the overlay error between the testing machine and the reference machine.

In summary, in the method for measuring the overlay error of an exposure machine according to the present invention, a pair of pre-fabricated matching mask and matching wafer is exposed in two machines. Then, the exposed images obtained from the two machines are subtracted to eliminate the errors produced by the matching mask and the matching wafer. Hence, a more accurate overlay error between the two exposure machines can be obtained so that a more effective control of the variations between the machines is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for measuring an overlay error of an exposure machine, suitable for measuring the overlay error of a testing machine, the method comprising the steps of:
performing an exposure with a reference machine to expose a matching wafer with a matching mask to obtain a first image;
performing an exposure with a testing machine to expose the matching wafer with the matching mask to obtain a second image;
subtracting the first image from the second image to obtain a third image; and
removing a linear error from the third image to obtain the overlay error.

2. The method of claim 1, wherein the exposure operations further includes:
adjusting an image of the reference machine and the testing machine so that the image is as close to the image on the matching wafer as possible.

3. The method of claim 1, further including a step of fabricating the matching wafer using the matching mask.

4. The method of claim 3, wherein the step of using the matching mask to fabricate the matching wafer comprises:
checking a number of machine conditions and selecting a machine with best machine conditions to serve as a mother machine; and
setting up the matching mask in the mother machine to fabricate the matching wafer.

5. The method of claim 4, wherein the machine conditions include stage accuracy, scan distortion error, stage stepping error and stage mirror bending error.

6. The method of claim 1, wherein the testing machine and the reference machine include steppers or scanners.

7. The method of claim 1, wherein the linear error includes wafer-wise linear error and shot-wise linear error.

8. The method of claim 7, wherein the wafer-wise linear error includes shifting error, scaling error and rotation error between wafers.

9. The method of claim 7, wherein the shot-wise linear error includes scaling error and rotation error between shots on a wafer.
